(19) United States
(12) Patent Application Publication
(10) Pub. No.: US 2008/0209368 A1
(43) Pub. Date: Aug. 28, 2008

(54) Layout design method, layout design apparatus, and computer product

(75) Inventors: Toshihiko Yokomaru, Kawasaki (JP); Takahide Yoshikawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/003,774

(22) Filed: Dec. 31, 2007

(30) Foreign Application Priority Data
Feb. 22, 2007 (JP) 2007-042208

(51) Int. Cl. G06F 17/50

(52) U.S. Cl. 716/5; 716/13

(57) ABSTRACT

An apparatus for designing the layout of a circuit includes an acquiring unit, a determining unit, a specifying unit, an arranging unit, a modifying unit, and a routing unit. Based on net information acquired by the acquiring unit, the determining unit determines a wiring block of signal paths connecting cells connected through adjacent. The arranging unit arranges a wiring area between the cells that extends along user-specified reference points or user-specified reference segments received by the specifying unit. The modifying unit modifies the arranged wiring area and the routing unit routes the signal paths of the wiring block in the modified wiring area.

### CROSS-REFERENCE TO RELATED APPLICATIONS

This application is based upon and claims the benefit of priority from the prior Japanese Patent Application No. 2007-042208, filed on Feb. 22, 2007, the entire contents of which are incorporated herein by reference.

### BACKGROUND OF THE INVENTION

1. Field of the Invention

The present invention relates to semiconductor integrated circuit layout design.

2. Description of the Related Art

In recent years, in the design of semiconductor integrated circuits, a layout design apparatus that can automatically generate layout information, such as a netlist, based on logical function data written in, for example, a hardware description language (HDL) and can automatically arrange wiring based on the layout information has been utilized.

The use of such an apparatus in the layout design of semiconductor integrated circuits, e.g., application specific integrated circuits (ASIC) and field programmable gate arrays (FPGA), enables a shortening of the layout design period.

However, even if the layout design apparatus is used to automatically arrange wiring, correction work based on design rules for, for example, delay, wiring intervals, electric power, and the effect of noise must be manually performed in most cases. Recent semiconductor integrated circuits have millions of wiring lines, and due to the correction work involved, the problem of a prolonged layout design period could not be solved.

Thus, for example, a layout design program that enables wiring or wiring correction in groups by grouping plural signal paths having any common point (e.g., signal paths that are adjacent to or overlap each other, signal paths whose net angle difference is smaller than a threshold value, or signal paths having a common name) has been proposed (see, for example, Japanese Patent Application Laid-open Publications No. 1992-115368 and No. 1992-275679). Performing layout design using such a method enables reduction of the layout design period.

However, in grouped signal paths, although a state in which signal arrival times of the respective signal paths are uniform as far as possible is desirable, grouping that takes into consideration the signal arrival times of the signal paths cannot be executed in conventional technologies, such as those disclosed in Japanese Patent Application Laid-open Publications No. H4-115368 and No. H4-275679. Therefore, in the grouped signal paths, a user must manually correct wiring, cell arrangement, group configuration, etc. such that the signal arrival times of the respective signal paths become uniform, thereby prolonging the layout design period.

In the conventional technologies disclosed in Japanese Patent Application Laid-open Publications No. H4-115368 and No. H4-275679, signal paths cannot be arranged in a particular area intended by a user. Therefore, the user must manually correct the signal path that has been arranged to be in the intended area, resulting in a problem of prolonging the layout design period.

In view of the problems with the conventional technologies, it is an object of the present invention to provide a layout design technique that can perform grouping with consideration of the signal arrival times of signal paths and decrease correction work during layout design by arranging the signal paths in a area intended by a user to thereby reduce the layout design period.

### SUMMARY OF THE INVENTION

It is an object of the present invention to at least solve the above problems in the conventional technologies.

A computer-readable recording medium, according to one aspect of the present invention stores, therein a circuit layout design computer program that causes a computer to execute determining a wiring block of a plurality of signal paths that connect a plurality of cells connected through a plurality of adjacent nets, wherein the determining is based on at least one of a slack value, a signal arrival time, arrangement coordinates of a starting point terminal and an ending point terminal, a name, an angle, and a schematic wiring path included in information concerning the adjacent nets.

A circuit layout design method according to another aspect of the present invention includes determining a wiring block of a plurality of signal paths that connect a plurality of cells connected through a plurality of adjacent nets, wherein the determining is based on at least one of a slack value, a signal arrival time, arrangement coordinates of a starting point terminal and an ending point terminal, a name, an angle, and a schematic wiring path included in information concerning the adjacent nets.

A circuit layout design apparatus according to still another aspect of the present invention includes a determining unit that determines a wiring block of a plurality of signal paths that connect a plurality of cells connected through a plurality of adjacent nets, wherein the determining unit determines based on at least one of a slack value, a signal arrival time, arrangement coordinates of a starting point terminal and an ending point terminal, a name, an angle, and a schematic wiring path included in information concerning the adjacent nets.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a layout design apparatus according to an embodiment of the present invention;

FIG. 2 is a functional diagram of the layout design apparatus;

FIG. 3 is a schematic of a circuit used in the layout design apparatus;

FIG. 4 is a table illustrating an example of net information used in the layout design apparatus;

FIG. 5 is a flowchart of determination processing performed by the determining unit;

FIG. 6 is a flowchart of layout design processing performed by the layout design apparatus;

FIG. 7 is a schematic of reference points specified at a specifying unit;

FIG. 8 is a schematic of a specified reference segment;

FIG. 9 is a schematic of a wiring area arranged by an arranging unit;

FIG. 10 is a schematic of an arranged wiring area that has been modified by a modifying unit;

FIG. 11 is a schematic of the circuit subjected to signal path routing by a routing unit;

FIG. 12 is a schematic of the circuit after modification of the layout;

FIG. 13 is a schematic of a wiring area that has been modified by a modifying unit;

FIG. 14 is a schematic of the circuit subjected to signal path routing by the routing unit after a layout modification;

FIG. 15 is a schematic of a reference segment specified at the specifying unit; and

FIG. 16 is a schematic of a wiring area arranged by the arranging unit.

### DETAILED DESCRIPTION OF THE PREFERRED EMBODIMENTS

Referring to the accompanying drawings, exemplary embodiments according to the present invention are explained in detail below.

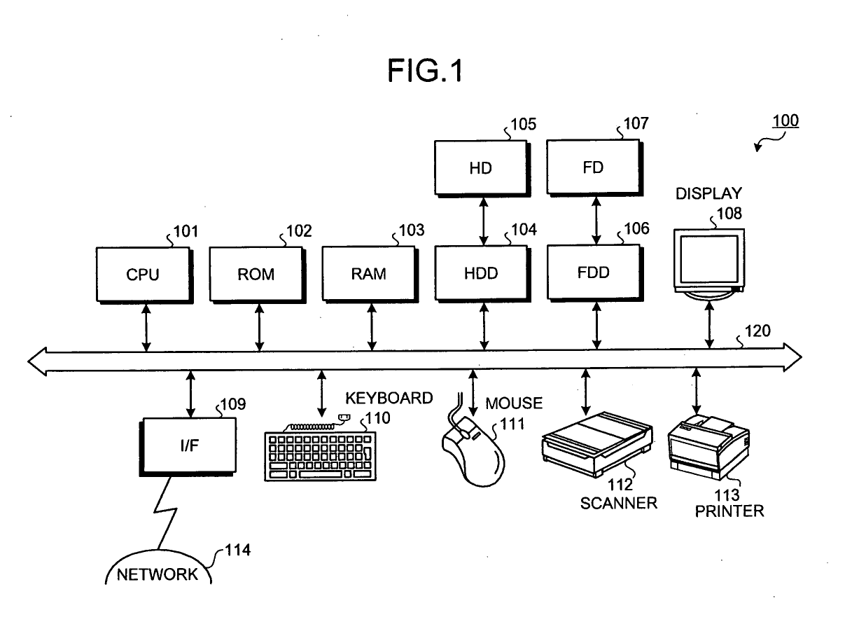

FIG. 1 is a block diagram of a layout design apparatus according to the embodiment of the present invention. As shown in FIG. 1, a layout design apparatus 100 includes a central processing unit (CPU) 101, a read-only memory (ROM) 102, a random access memory (RAM) 103, a hard disk drive (HDD) 104, a hard disk (HD) 105, a flexible disk drive (FDD) 106, a flexible disk (FD) 107 as an example of a detachable recording medium, a display 108, an interface (I/F) 109, a keyboard 110, a mouse 111, a scanner 112, and a printer 113. The constituent units are respectively connected through a bus 120.

The CPU 101 controls the entire layout design apparatus 100. The ROM 102 stores a program, e.g., a boot program. The RAM 103 is used as a work area of the CPU 101. The HDD 104 controls the writing/reading of data to/from the HD 105 under the control of the CPU 101. The HD 105 stores data written under the control of the HDD 104.

The FDD 106 controls the writing/reading of data to/from the FD 107 under the control of the CPU 101. The FD 107 stores data written under the control of the FDD 106 and the data stored therein is read.

Besides the FD 107, the detachable recording medium may be, for example, a compact disk read-only memory (CD-ROM), compact disk-recordable (CD-R), a compact disk-rewritable (CD-RW), a magneto optical disk (MO), a digital versatile disk (DVD), or a memory card. The display 108 displays a cursor, an icon, a tool box, as well as data, such as text, images, or function information. As the display 108, for example, a CRT, a TFT liquid crystal display, or a plasma display can be adopted.

The I/F 109 is connected to a network 114, such as the Internet, via a communication line to be further connected with other devices through the network 114. The I/F 109 controls the interface between the apparatus and the network 114, and controls output/input of data to/from an external device. As the I/F 109, for example, a modem or a local area network (LAN) adapter can be used.

The keyboard 110 includes keys for inputting, for example, characters, numeric figures, or various kinds of commands, and is used to input data. A touch panel type input pad or a numeric keypad may substitute for the keyboard 110. The mouse 111 is used to move a cursor, select a range, move a window, and change a window size. A device such as a track ball or a joystick may substitute for the mouse provided the device has the same function as a pointing device.

The scanner 112 optically reads an image into the layout design apparatus 100 as image data. The scanner 112 may have an optical character recognition (OCR) function. The printer 113 produces a hard copy of image data or text data. As the printer 113, for example, a laser printer or an inkjet printer can be adopted.

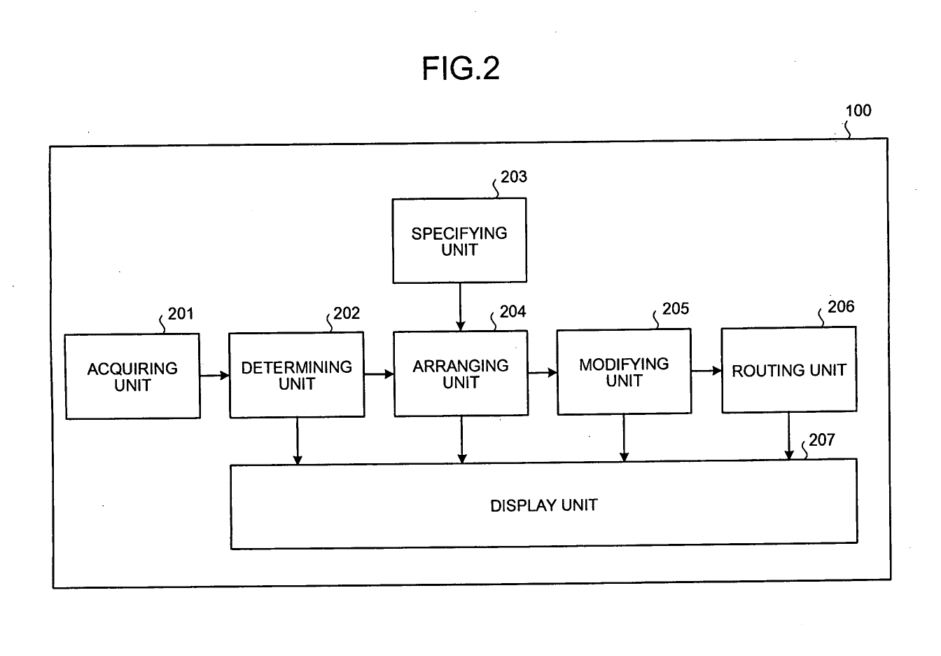

FIG. 2 is a functional diagram of the layout design apparatus 100. As shown in FIG. 2, the layout design apparatus 100 includes an acquiring unit 201, a determining unit 202, a specifying unit 203, an arranging unit 204, a modifying unit 205, a routing unit 206, and a display unit 207.

The acquiring unit 201 acquires layout information concerning a layout of a circuit to be designed, e.g., a netlist. The acquiring unit 201 also acquires net information, such as a slack value, a signal arrival time, arrangement coordinates of a starting point terminal and an ending point terminal, a name, an angle, a schematic wiring path, etc. concerning nets that are adjacent to each other and provided in the circuit layout. The acquiring unit 201 also acquires layout modification information concerning a modification of the circuit layout.

Specifically, the layout information, the net information, and the layout modification information are read from a predetermined recording medium, such as the ROM 102, the RAM 103, the HD 105, or the FD 107 depicted in FIG. 1. Such information may be produced by the layout design apparatus 100 or external apparatuses. For example, the net information may be obtained by a calculation executed by the layout design apparatus 100 or by an external apparatus.

The acquiring unit 201 may acquire the layout information, the net information, and the layout modification information transmitted from an external apparatus connected with the layout design apparatus 100 via the network 114 depicted in FIG. 1. Specifically, for example, the function of the acquiring unit 201 is implemented by the I/F 109 that is controlled when the CPU 101 executes a program stored in the ROM 102, the RAM 103, the HD 105, or the FD 107 depicted in FIG. 1.

The determining unit 202 determines, based on the net information, a block of adjacent nets for which signal paths are to be wired concurrently. The adjacent nets are the nets indicated, in the layout information, to be adjacent. The signal paths connect the cells of the nets.

Specifically, for example, slack values and signal arrival times concerning the adjacent nets indicated in the net information are used to group the adjacent nets. The adjacent nets are grouped when the difference between the slack values is smaller than a given threshold value and when the difference between the signal arrival times is smaller than a given threshold value.

The method of grouping the nets is not restricted to the foregoing method, and nets whose arrangement coordinates of starting point terminals or ending point terminals are close to each other may be grouped, nets that include relevant character strings in their names may be grouped, or nets whose schematic wiring paths are adjacent to or overlap each other may be grouped, for example.

A specific procedure of the determination processing performed by the determining unit 202 will be explained in detail hereinafter with reference to FIG. 4. Specifically, the function of the determining unit 202 is implemented when the CPU 101 executes a program stored in, for example, the ROM 102, the RAM 103, the HD 105, or the FD 107 depicted in FIG. 1.

The specifying unit 203 receives specification of reference points or reference segments that serve as a reference for arranging a wiring area between cells that are connected through the adjacent nets. Specifically, the specifying unit 203 receives, as the reference points or the reference segments, points or segments that are input between the cells connected through the adjacent nets. The points or segments are input by a user operating the keyboard 110 or the mouse 111 depicted in FIG. 1 to arrange the wiring area. The reference points or the reference segments are used to arrange a wiring area that extends along the reference points or the reference segments in a direction(s) that complies with the wiring direction(s) specified in the design rules. Specifically, the function of the specifying unit 203 is implemented by, for example, the keyboard 110 or the mouse 111 depicted in FIG. 1.

The arranging unit 204 arranges a wiring area along the reference points or the reference segments in accordance with the wiring direction. For example, the arranging unit 204 uses the reference points or the reference segments as a reference to arrange the wiring area. When the user specifies a size of the wiring area, a wiring area having the specified size is arranged. When the user does not specify a size of the wiring area, the arranging unit 204 uses the reference points or the reference segments to arrange a wiring area having a size calculated by using the resistance of a unit length, the capacitance of a unit length, or a slack value. Additionally, a larger size may be set as a minimum size to prevent parallel wiring length errors, for example. Specifically, the arranging unit 204 realizes its function when the CPU 101 executes a program stored in, e.g., the ROM 102, the RAM 103, the HD 105, or the FD 107 depicted in FIG. 1.

When the user does not specify a size of the wiring area, the modifying unit 205 modifies the wiring area that has been automatically arranged by the arranging unit 204. For example, when the modifying unit 205 determines (as a result of calculating or acquiring the delay, the power consumption, and the degree of wiring congestion) that delay and power consumption are smaller than constraint values and congestion around the wiring area is not high, the modifying unit 205 modifies the wiring area to enable wider wiring pitches. The size of the wiring area is modified such that the degree of wiring congestion, the wiring delay, and the power consumption will fall within the constraint value ranges. When the user has specified the size of the wiring area, the modifying unit 205 does not modify the wiring area arranged by the arranging unit 204.

When the acquiring unit 201 acquires the layout modification information, the modifying unit 205 can modify, based on the acquired layout modification information, an existing wiring area arranged by the arranging unit 204. The modifying unit 205 specifically realizes its function when the CPU 101 executes a program stored in, for example, the ROM 102, the RAM 103, the HD 105, or the FD 107 depicted in FIG. 1.

The routing unit 206 routes, in the wiring area modified by the modifying unit 205, the signal paths of the block of adjacent nets determined by the determining unit 202. Specifically, the routing unit 206 realizes its function when the CPU 101 executes a program stored in, e.g., the ROM 102, the RAM 103, the HD 105, or the FD 107 depicted in FIG. 1.

The display unit 207 displays, for example, a layout based on the layout information acquired by the acquiring unit 201, the reference points or the reference segments specified at the specifying unit 203, the wiring area arranged by the arranging unit 204, the wiring area modified by the modifying unit 205, or a layout after the routing of signal paths by the routing unit 206. Specifically, the display unit 207 realizes its function by, for example, the display 108 depicted in FIG. 1.

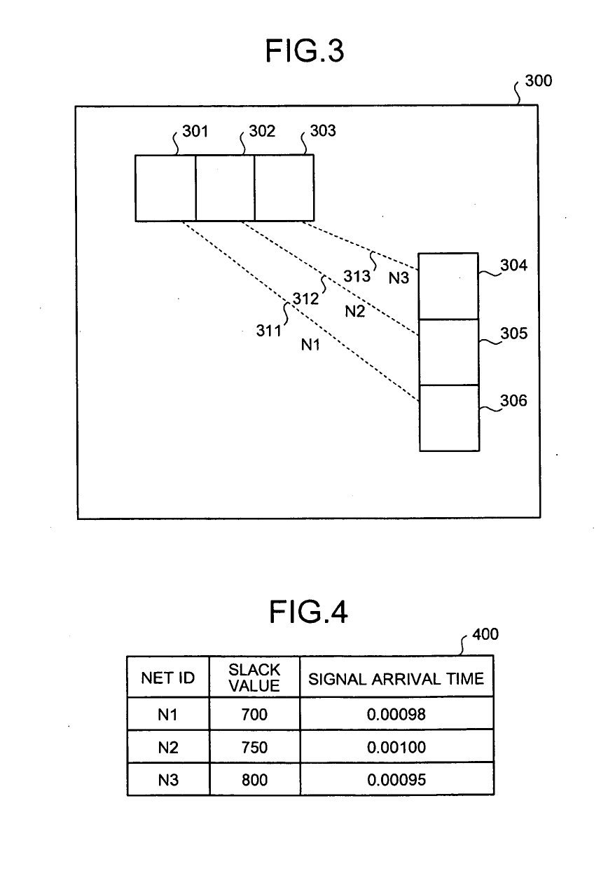

FIG. 3 is a schematic of a circuit used in the layout design apparatus 100. As shown in FIG. 3, the circuit 300 is formed of cells 301, 302, 303, 304, 305, and 306 and nets 311, 312, and 313. Of these nets, the net 311 has a net ID “N1” that is used to uniquely identify the net and connects the cell 301 with the cell 306. The net 312 has a net ID “N2” and connects the cell 302 with the cell 305. The net 313 has a net ID “N3” and connects the cell 303 with the cell 304.

FIG. 4 is a table illustrating an example of the net information used in the layout design apparatus 100. As shown in FIG. 4, net information 400 is information concerning the nets 311, 312, and 313 depicted in FIG. 3. Among the net information 400, the slack value of a signal path corresponding to a net is listed in a column “slack value”. The signal arrival time in a signal path corresponding to a net is listed in a column “signal arrival time”.

For example, it can be understood from the net information 400 depicted in FIG. 4 that the slack value of a signal path corresponding to the net having the net ID “N1” is “700” and the signal arrival time in a signal path corresponding to the net having the net ID “N1” is “0.00098 (milliseconds)”.

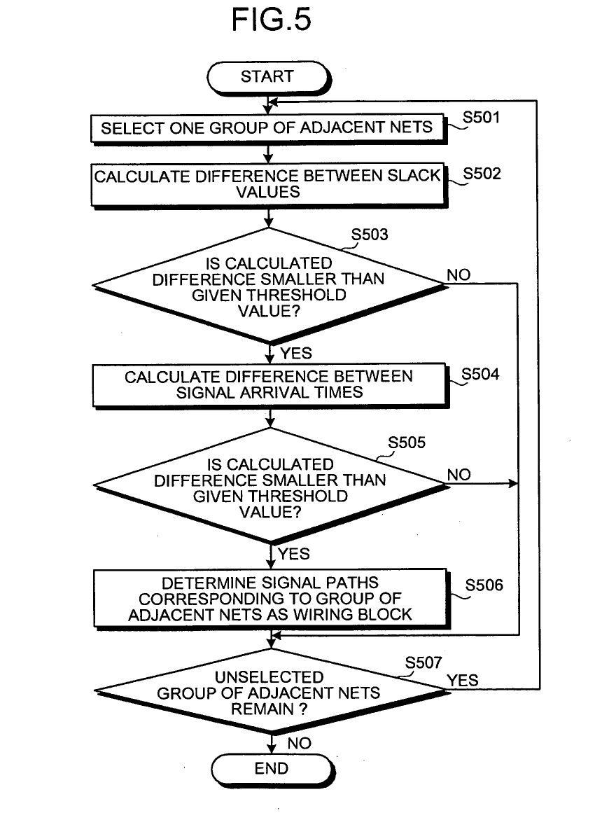

FIG. 5 is a flowchart of determination processing performed by the determining unit 202. First, one group of adjacent nets is selected from the nets indicated in the layout information acquired by the acquiring unit 201 (step S501). Then, the difference(s) between slack values of the nets of the group selected at step S501 is calculated based on the net information acquired by the acquiring unit 201 (step S502), and it is judged whether the difference(s) calculated at step S502 is smaller than a given threshold value (step S503).

When the difference(s) is judged to be larger than the given threshold value at step S503 (step S503: NO), the process proceeds to step S507. On the other hand, when the difference(s) is judged to be smaller than the given threshold value at step S503 (step S503: YES), the difference(s) between signal arrival times of the nets of the group selected at step S501 is calculated based on the net information obtained by the acquiring unit 201 (step S504).

It is judged whether the difference(s) calculated at step S504 is smaller than a given threshold value (step S505). When the difference(s) is judged to be larger than the given threshold value at step S505 (step S505: NO), the process proceeds to the step S507. On the other hand, when the difference(s) is judged to be smaller than the given threshold value at step S505 (step S505: YES), the selected group is determined as a block of adjacent nets for which signal paths are to be wired concurrently and the corresponding signal paths form a wiring block (step S506), and the process proceeds to the step S507.

It is judged whether a group of adjacent nets remains among the nets indicated in the layout information acquired by the acquiring unit 201 (step S507). When it is judged at step S507 that no group remains (step S507: NO), a series of processing is terminated. On the other hand, when it is judged at step S507 that a group remains (step S507: YES), steps S501 to S506 are repeatedly executed until it is judged at step S507 that no group remains.

For example, assume the nets 311, 312, and 313 depicted in FIG. 3 are used to execute the foregoing determination processing and the given threshold value for the slack values is “100” while the given threshold value for the signal arrival times is “0.00010 (milliseconds)”.

The difference between the slack values of the net 311 and the net 312 is “50”, which is smaller than the given threshold value, and the difference between the signal arrival times of the net 311 and the net 312 is “0.00002 (milliseconds)”, which is smaller than the threshold value. Therefore, a signal path connecting the cells connected through the net 311 and a signal path connecting the cells connected through the net 312 are determined to be in the same wiring block.

Likewise, the difference between the slack values of the net 312 and the net 313 is “50”, which is smaller than the given threshold value, and the difference between the signal arrival times of the net 312 and the net 313 is “0.00005 (milliseconds)”, which is smaller than the given threshold value. Therefore, a signal path connecting the cells connected through the net 312 and a signal path connecting the cells connected through the net 313 are determined to be in the same wiring block.

As explained above, the layout design apparatus 100 can determine a wiring block of the signal paths based on the slack values and the signal arrival times indicated in the net information acquired by the acquiring unit 201.

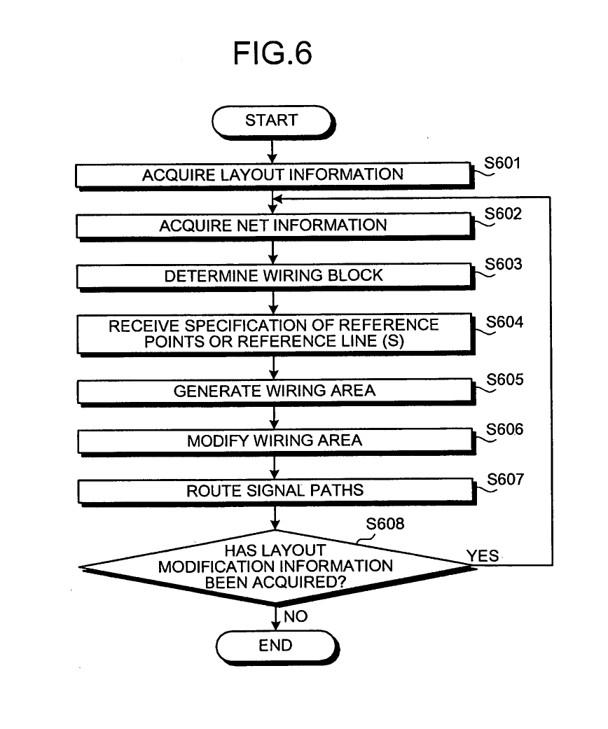

FIG. 6 is a flowchart of layout design processing performed by the layout design apparatus 100. First, the acquiring unit 201 acquires the layout information (step S601). Then, the acquiring unit 201 acquires the net information (step S602).

Subsequently, the determining unit 202 uses the net information acquired at step S602 to determine a wiring block of signal paths connecting the cells that are connected through nets adjacent to each other among the nets indicated in the layout information acquired at step S601 (step S603). (Refer to wiring block determination processing explained above with reference to FIG. 5.)

Next, the specifying unit 203 receives specification of reference points or reference segments between the cells connected through the adjacent nets (step S604). Subsequently, the arranging unit 204 arranges a wiring area extending along the reference points or the reference segments specified at step S604 (step S605).

The modifying unit 205 modifies the wiring area arranged at step S605 (step S606), and the routing unit 206 routes the signal paths of the wiring block determined at step S603 in the wiring area modified at step S606 (step S607).

Then, it is judged whether layout modification information has been acquired by the acquiring unit 201 (step S608). When the layout modification information is judged to have been acquired at step S608 (step S608: YES), the process returns to the step S602 to execute layout design processing (steps S602 to S607) as the layout of the circuit has been modified. At this time, since the reference points or the reference segments have already been specified, the processing of receiving the reference points or the reference segments at the specifying unit 203 (step S604) can be omitted. On the other hand, when the layout modification information is judged not to have been acquired at step S608 (step S608: NO), a series of processing is terminated.

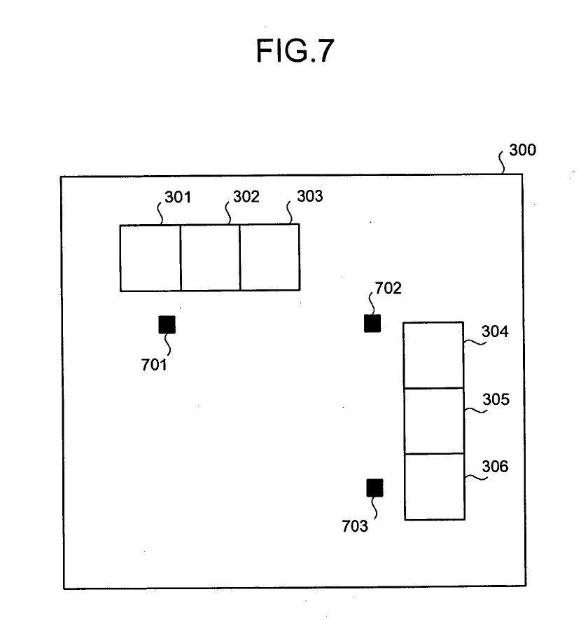

FIG. 7 is a schematic of reference points specified at the specifying unit 203. FIG. 7 depicts reference points 701, 702, and 703 specified at the specifying unit 203 for the circuit 300 depicted in FIG. 3. The reference points 701, 702, and 703 serve as references when arranging a wiring area of a signal path connecting a cell 301 with a cell 306, a signal path connecting a cell 302 with a cell 305, and a signal path connecting a cell 303 with a cell 304 by the arranging unit 204.

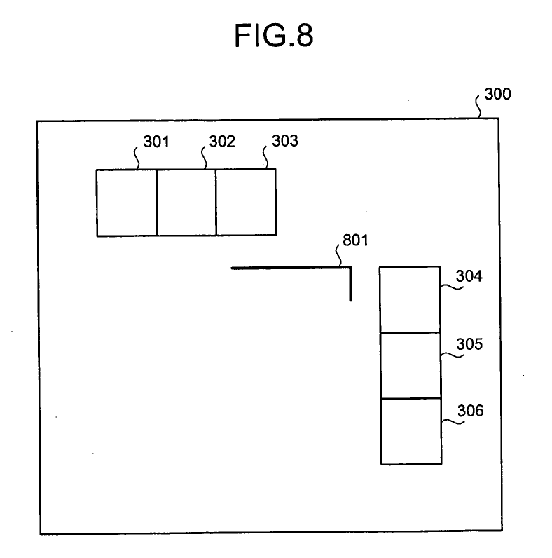

FIG. 8 is a schematic of a specified reference segment. FIG. 8 depicts reference segments 801 specified, at the specifying unit 203, for the circuit 300. Similar to the reference points 701, 702, and 703 depicted in FIG. 7, the reference segments 801 serves as a reference when arranging the wiring area of the signal path connecting the cell 301 with the cell 306, the signal path connecting the cell 302 with the cell 305, and the signal path connecting the cell 303 with the cell 304 by the arranging unit 204.

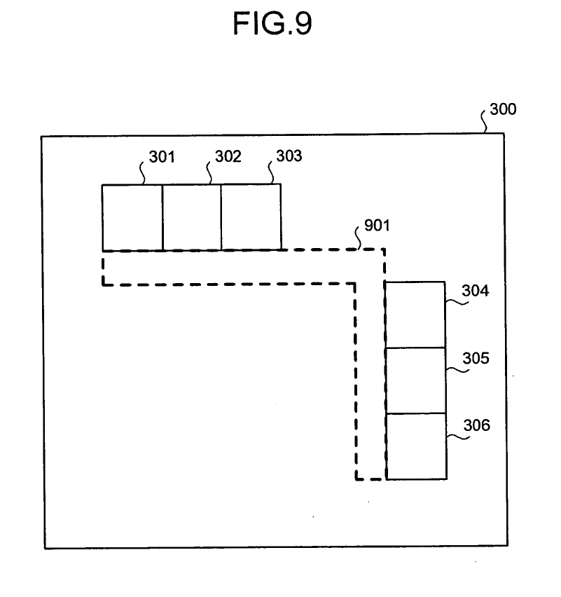

FIG. 9 is a schematic of a wiring area 901 on the circuit 300 arranged by the arranging unit 204. As shown in FIG. 9, the wiring area 901 extends along the reference points 701, 702, and 703 depicted in FIG. 7 and the reference segments 801 depicted in FIG. 8.

In this manner, the layout design apparatus 100 according to the embodiment of the present invention can arrange the wiring area of the signal paths by a simple operation involving user specification of the reference points or the reference segments.

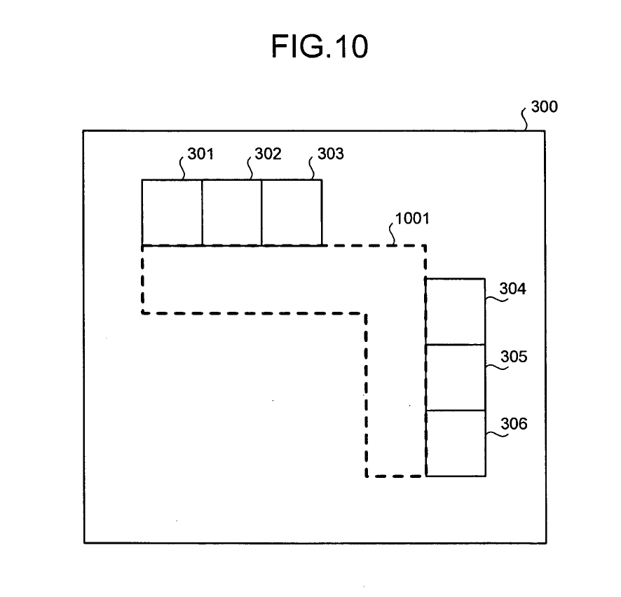

FIG. 10 is a schematic of an arranged wiring area that has been modified by the modifying unit 205. As shown in FIG. 10, similar to the wiring area 901 depicted in FIG. 9, a wiring area 1001 is arranged extending along the reference points 701, 702, and 703 depicted in FIG. 7 and the reference segments 801 depicted in FIG. 8. However, with consideration of delay, electric power, and wiring congestion, the wiring area 1101 has a larger area than that of the wiring area 901 to allow leeway for additional wiring (without requiring diversion), and increasing the wiring interval, etc. In this manner, the layout design apparatus 100 according to the embodiment of the present invention can automatically modify the already arranged wiring area based on delay, electric power, and wiring congestion.

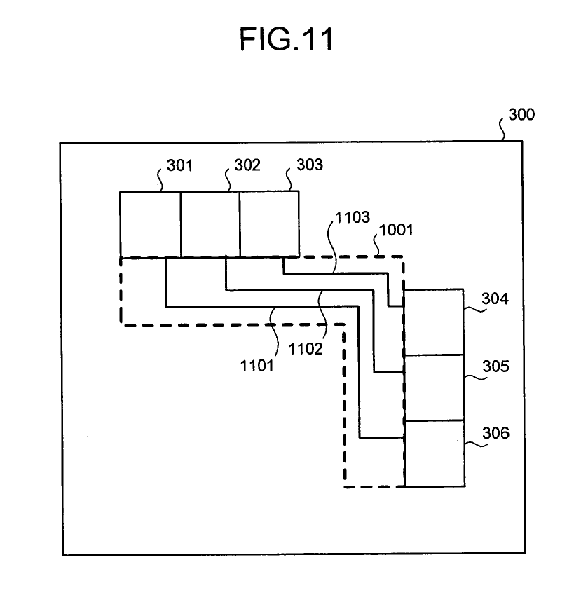

FIG. 11 is a schematic of the circuit 300 subjected to signal path routing by the routing unit 206. As shown in FIG. 11, in the circuit 300, a signal path 1101 connecting the cell 301 with the cell 306, a signal path 1102 connecting the cell 302 with the cell 305, and a signal path 1103 connecting the cell 303 with the cell 304 are routed in the wiring area 1001 shown in FIG. 10.

In this manner, the layout design apparatus 100 can route the signal paths in the wiring area 1001 that has been arranged and modified based on the reference points 701, 702, and 703 or the reference segments 801 specified by the user.

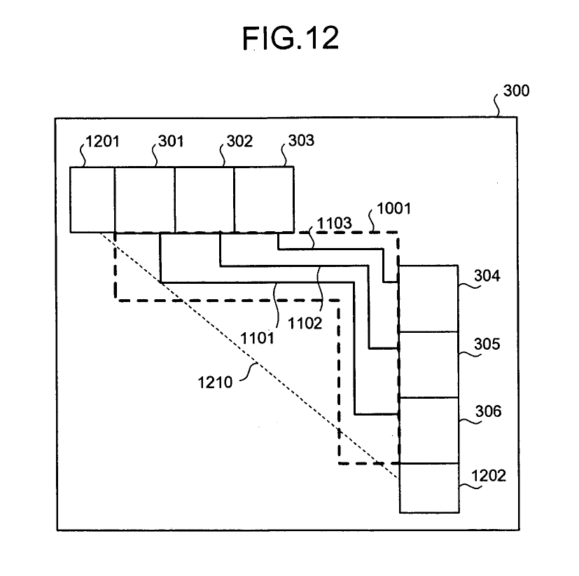

FIG. 12 is a schematic of the circuit 300 having a layout that has been modified after the signal path routing (shown in FIG. 11) has been executed. As shown in FIG. 12, in the circuit 300, a cell 1201 and a cell 1202 have been added, and a net 1210 connecting the cell 1201 with the cell 1202 has been added.

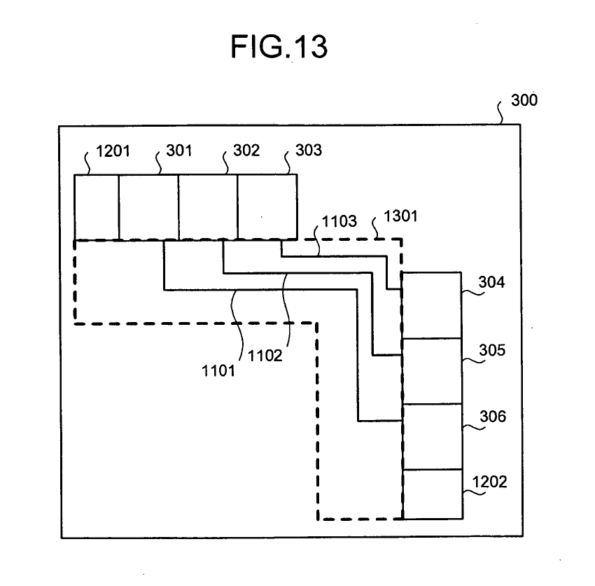

FIG. 13 is a schematic of a wiring area that has been modified by the modifying unit 205 after the layout of the circuit 300 has been modified as shown in FIG. 12. As depicted in FIG. 12, similar to the wiring area 1001 depicted in FIG. 10, the wiring area 1301 is arranged extending along the reference points 701, 702, and 703 shown in FIG. 7 and the reference segments 801 shown in FIG. 8. However, the wiring area 1301 has a larger area than that of the wiring area 1001 to accommodate routing of a signal path connecting the cell 1201 with the cell 1202.

In this manner, even when the circuit 300 is modified, the layout design apparatus 100 can modify an existing wiring area based on the existing specified reference points and/or reference segments without requiring the user newly specify reference points or reference segments.

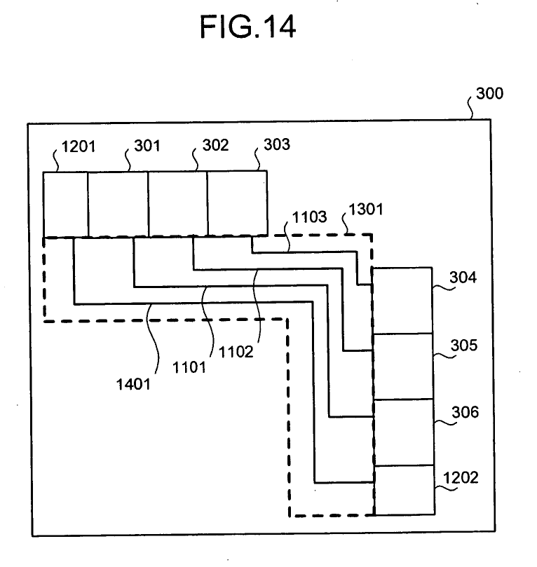

FIG. 14 is a schematic of the circuit 300 subjected to signal path routing by the routing unit 206 after a layout modification. As shown in FIG. 14, in the circuit 300 (see FIG. 12) having the modified layout, a signal path 1401 connecting the cell 1201 with the cell 1202, as well as the signal path 1101, the signal path 1102, and the signal path 1103 already routed in the wiring area 1301, is further routed in therein.

As explained above, even when the circuit 300 is modified, the layout design apparatus 100 can modify an existing wiring area based on the existing specified reference points and/or reference segments and then route a signal path connecting the cells in the modified wiring area without requiring the user to newly specify reference points or a reference segments.

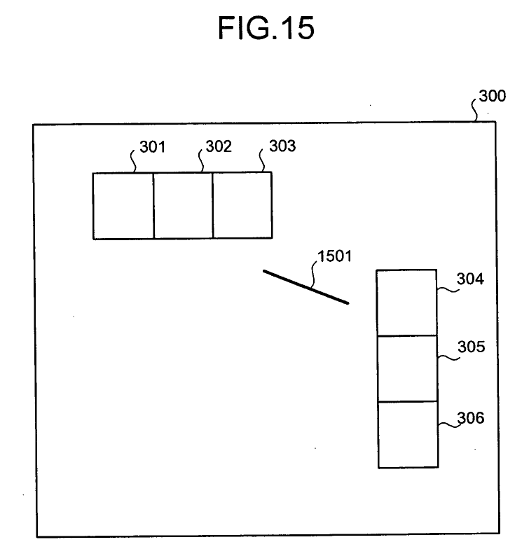

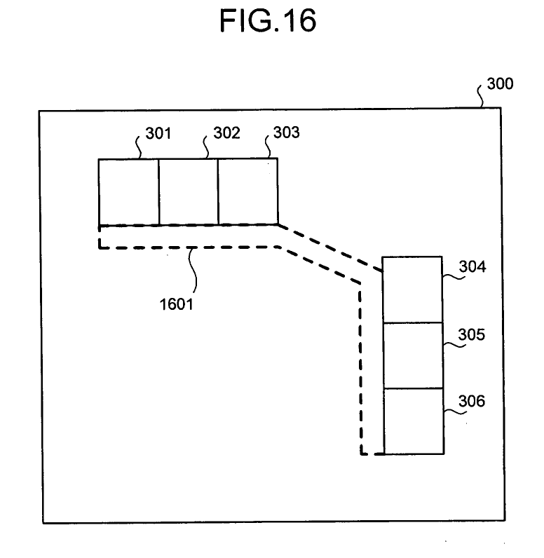

FIG. 15 is a schematic of a reference segment specified at the specifying unit 203. FIG. 16 is a schematic of a wiring area arranged by the arranging unit 204. FIG. 15 depicts a reference segment 1501 specified for the circuit 300 (see FIG. 3). FIG. 16 depicts a wiring area 1601 arranged based on the reference segment 1501 shown in FIG. 15. In this manner, in the layout design processing according to the embodiment, the reference segment serving as a reference during arranging of the wiring area can be obliquely specified. The wiring area can be arranged along the obliquely specified reference segment to extend from the ends thereof.

As explained above, net information is acquired, a block of signal paths to be routed adjacently is determined based on the acquired net information, and the signal paths are routed accordingly. Therefore, for layout design that includes wiring, signal paths adjacent to each other can be processed in a block based on timing, such as, delay. As a result, grouping with consideration of signal arrival times of the signal paths can be executed, and hence correction work during layout design can be reduced, thereby effecting reduction of the layout design period.

When a difference between slack values shown in the net information is smaller than a given threshold value and when a difference between signal arrival times shown in the net information is smaller than a given threshold value, the signal paths adjacent to each other are processed in the same wiring block. Therefore, for the layout design involving the wiring of the signal paths adjacent to each other, having a high need for timing synchronization, such as delay, can be processed in the same wiring block. As a result, grouping with consideration of signal arrival times of the signal paths can be executed, and hence correction work during layout design can be reduced, thereby effecting shortening of the layout design period.

Specification of reference points or reference segments is received, and a wiring area is arranged extending along the specified reference points or reference segments. Therefore, the wiring area of signal paths adjacent to each other can be arranged based on simple information, i.e., the reference points or the reference segments. Consequently, since the signal path can be routed in an area intended by the user by simply specifying the reference points or the reference segments, correction work during layout design can be reduced, thereby reducing the layout design period.

An existing wiring area is modified based on delay, power consumption, and the degree of wiring congestion. As a result, for example, even when a layout is modified and wiring is thereby added, the added wiring can be routed in the wiring area (without being diverted) in such a manner that the signal arrival time of the added wiring is the same as the signal arrival times of the other wiring segments. Wiring pitches can be increased to reduce the effects of noise among the wiring. As an existing arranged wiring area can be automatically modified based on delay, power consumption, and wiring congestion, correction work during layout design can be reduced, thereby effecting a shortened layout design period.

Layout modification information is acquired, and an existing arranged wiring area is modified based on the acquired layout modification information. Therefore, when a layout is modified, an existing arranged wiring area can be modified to accommodate the layout modification without again requiring specification of reference points or reference segments. As a result, even when the layout is modified, a signal path can be routed in an area intended by a user without requiring the user to newly specify the reference points or the reference segments, and hence correction work during layout design can be reduced, thereby reducing a layout design period.

According to the layout design method and the layout design apparatus explained in the present embodiment, grouping that takes into consideration the signal arrival times of signal paths can be executed and the signal path can be routed in an area intended by a user. As a result, correction work during layout design can be decreased, thereby effecting reduction of the layout design period.

The layout design method explained in the present embodiment can be implemented by a computer such as a personal computer and a workstation executing a program (such for computer-aided design (CAD)) that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium storing therein a circuit layout design computer program that causes a computer to execute:
determining a wiring block of a plurality of signal paths that connect a plurality of cells connected through a plurality of adjacent nets, wherein
the determining is based on at least one of a slack value, a signal arrival time, arrangement coordinates of a starting point terminal and an ending point terminal, a name, an angle, and a schematic wiring path included in information concerning the adjacent nets.

2. The computer-readable recording medium according to claim 1, wherein the computer program further causes the computer to execute routing the signal paths of the wiring block.

3. The computer-readable recording medium according to claim 1, wherein the computer program further causes the computer to execute:
receiving specification of a plurality of points or segments between the cells; and
arranging a wiring area that is for the routing of the signal paths of the wiring block, and extends along and from the points or the segments received at the receiving.

4. The computer-readable recording medium according to claim 3, wherein the computer program further causes the computer to execute routing, in the wiring area, the signal paths of the wiring block.

5. The computer-readable recording medium according to claim 3, wherein the computer program further causes the computer to execute modifying the wiring area, based on at least one of a delay, a power consumption, and a degree of routing congestion included in information concerning the wiring area.

6. The computer-readable recording medium according to claim 5, wherein the computer program further causes the computer to execute routing, in the wiring area modified at the modifying, the signal paths of the wiring block.

7. A circuit layout design method comprising:
determining a wiring block of a plurality of signal paths that connect a plurality of cells connected through a plurality of adjacent nets, wherein
the determining is based on at least one of a slack value, a signal arrival time, arrangement coordinates of a starting point terminal and an ending point terminal, a name, an angle, and a schematic wiring path included in information concerning the adjacent nets.

8. The circuit layout design method according to claim 7, wherein the computer program further causes the computer to execute routing the signal paths of the wiring block.

9. The circuit layout design method according to claim 7, wherein the computer program further causes the computer to execute:
receiving specification of a plurality of points or segments between the cells; and
arranging a wiring area that is for routing of the signal paths of the wiring block, and extends along and from the points or the segments received at the receiving.

10. The circuit layout design method according to claim 9, wherein the computer program further causes the computer to execute routing, in the wiring area, the signal paths of the wiring block.

11. The circuit layout design method according to claim 9, wherein the computer program further causes the computer to execute modifying the wiring area, based on at least one of a delay, a power consumption, and a degree of wiring congestion included in information concerning the wiring area.

12. The circuit layout design method according to claim 11, wherein the computer program further causes the computer to execute routing, in the wiring area modified at the modifying, the signal paths of the wiring block.

13. A circuit layout design apparatus comprising:
a determining unit that determines a wiring block of a plurality of signal paths that connect a plurality of cells connected through a plurality of adjacent nets, wherein
the determining unit determines based on at least one of a slack value, a signal arrival time, arrangement coordinates of a starting point terminal and an ending point terminal, a name, an angle, and a schematic wiring path included in information concerning the adjacent nets.

14. The circuit layout design apparatus according to claim 13, further comprising a routing unit that routes the signal paths of the wiring block.

15. The circuit layout design apparatus according to claim 13, further comprising:
a specification unit that receives specification of a plurality of points or segments between the cells; and
an arranging unit that arranges a wiring area that is for routing of the signal paths of the wiring block, and extends along and from the points or the segments received at the receiving.

16. The circuit layout design apparatus according to claim 15, further comprising a routing unit that routes, in the wiring area, the signal paths of the wiring block.

17. The circuit layout design apparatus according to claim 15, further comprising a modifying unit that modifies the wiring area, based on at least one of a delay, a power consumption, and a degree of wiring congestion included in information concerning the wiring area.

18. The circuit layout design apparatus according to claim 17, further comprising a routing unit that routes, in the wiring area modified at the modifying, the signal paths of the wiring block.
